(19) United States
(12) Patent Application Publication
(10) Pub. No.: US 2008/0007612 A1
(43) Pub. Date: Jan. 10, 2008

(54) Multiplexed image distribution system

(75) Inventors: Patrick Lagarrigue, Albi (FR); Marc Souviron, Toulouse (FR); Pierre-Yves Lambolez, Albi (FR)

Correspondence Address: ROTHWELL, FIGG, ERNST & MANBECK, P.C., 1425 K STREET, N.W., SUITE 800, WASHINGTON, DC, 20005, US

(73) Assignee: Synelec Telecom Multimedia Zone Industrielle, Saint Sernin sur Rance, Saint Sernin sur Rance (FR)

(21) Appl. No.: 11/003,974

(22) Filed: Dec. 6, 2004

(51) Int. Cl. H04N 7/14

(52) U.S. Cl. 348/14.1

(57) ABSTRACT

An image distribution system has a multiplexer (2) with inputs receiving images from images sources (4₁, 4₈). The multiplexer multiplexes images from said sources and provides on a connection (6) multiplexed images. Separate display devices (8, 10, 12) are connection in series to connection (6). Each display device has a demultiplexer (14, 16, 24) which receives multiplexed images and which outputs demultiplexed images. Using multiplexed sources and a single connection makes it possible to reduce the number of cables for distributing the images to the various display devices. The images displayed on one of the display devices may be changed at will without having to change the connection to the display device.

The invention relates to the field of displays and video walls. A video wall is formed of adjacent several displays, which define a continuous display surface. Strictly speaking, the display surface of a video wall is not continuous—since it is formed of the display surfaces of the different displays that form the video wall. However, the display surface appears continuous or almost continuous to the user; at least, it may be used as a continuous surface for the display of flows of images or videos over the whole surface of the video wall. The displays in a video wall may notably comprise projectors or LED panels. Video walls are for instance sold by the applicant under the trademark WallStation or by Electrosonic under the trademark Vector.

Prior art solutions in the field of video walls are discussed in EP patent application 02290587 filed on Mar. 8, 2002. For instance, Lanetco (Archamps, France) sells under the trademark SuperCube a rear projection system or projector, which may be assembled to provide a video wall. In order to display P sources on the eight projection systems of the video wall, one uses a commutation switch with P inputs and 16 outputs; each output would be connected to one live input of a projection system. Such a solution still requires 16 cables and 16 acquisition stages.

In addition, EP patent application 02290587 suggests multiplexing sources applying multiplexed sources to a video wall formed of several displays. The video wall contains one or more demultiplexer for receiving images from the multiplexed sources and for outputting images from demultiplexed sources. All displays in the wall are provided with images from demultiplexed sources. This makes it possible to show on any of the displays any of the demultiplexed images, without having to provide a commutation switch.

These solutions are adapted to the delivery of images to a video wall.

In a distinct field of the art, U.S. Pat. No. 6,229,849 discusses coding methods for digital broadcasting by satellite broadcast a plurality of programs processed by data compression coding using MPEG technique. Programs are frequency-multiplexed and transmitted with a fixed transmission rate, or with the transmission rate dynamically changed by a statistical multiplexing technique.

JP-A-2000 324 489 discusses a multi-screen image sending out system. The image to be displayed is divided into two or more fields, according to the number of screens of the multi-screen. The fields are multiplexed, transmitted and received. They are demultiplexed, and each field is sent to the relevant screen for display.

U.S. Pat. No. 5,691,777 discusses a teleconference system, with a number of monitors in various separate locations. A particular remote site selects the video signals he wishes to receive—that is selects some of the other participating sites. The video signals which were selected are multiplexed and selectively transmitted to the particular remote site.

Accordingly, there is a need for a solution permitting delivery of images to several display systems, which would not involve complex cabling or broadcasting.

The invention therefore provides, in one embodiment, an image distribution system, comprising
a multiplexer having at least two inputs adapted for receiving images from at least two sources, the multiplexer being adapted for multiplexing images received on said inputs and outputting on a connection multiplexed images;
a least two separate display devices, each of said separate display device being connected to the connection and having a demultiplexer adapted for receiving multiplexed images and outputting demultiplexed images.
   The system may also present one or more of the following features:
the multiplexer is adapted for time-multiplexing images received on the inputs;
the number of images per second for one source in the images from multiplexed sources is lower than the number of images per second for said source provided on said multiplexer input;
the demultiplexer in a display device is adapted to output demultiplexed images from any one of the multiplexed images
the display devices comprise a video wall having at least two displays forming a continuous or quasi-continuous display surface.

If the display devices comprise a video wall, it may comprise one demultiplexer, adapted to provide the images from demultiplexed sources to each of the displays forming the video wall. Alternatively, each display in the video wall could comprise a demultiplexer and a processor, a demultiplexer being adapted to the images from demultiplexed sources to the processor.

In another embodiment, the invention provides a process for distributing images to at least two separate display devices, the process comprising:
multiplexing images received from at least two sources;
providing over a connection multiplexed images to each of said separate display devices;
at each of said separate display devices, demultiplexing the received images and displaying images of at least one of said sources.

The multiplexing step preferably comprises time-multiplexing the received images. One may also reduce the number of images per second for at least one of the sources.

In the step of providing, all multiplexed images may be provided to each of the separate display devices. One may use a single connection, all display devices being serially connected on said connection.

The use of multiplexed sources makes it possible to reduce the number of cables for delivering images to several displays.

An image distribution system embodying the invention will now be described, by way of non-limiting example, and in reference to the accompanying drawings, where the figure shows a schematic view of the image distribution system.

The invention suggests multiplexing flows of images provided by sources, so as to be able to use a single cable for feeding the images of the multiplexed sources to the various display devices. These display devices are serially connected to the single cable. In case the necessary throughput for transmitting images to the display devices is higher than the throughput possible on the cable, the refresh rate of images of one source or more may be decreased, while keeping the same resolution.

In each of the display devices, images from multiplexed sources are received and demultiplexed before being displayed. Each of the display devices may select the demultiplexed sources it needs to display.

The invention makes it possible to use a single cable for various display devices, without having to provide a commutation switch. Further, it makes it possible to display the same images on several separate display devices, without duplicating cabling. Last, transmission on the cable may be digital, which avoids multiple analogue to digital and digital to analogue conversions.

In the rest of this description, the invention is described in reference to an exemplary image distribution system, using three display devices and eight sources. The figure first shows a multiplexer 2, the input terminals of which are connected to sources 4₁ to 4₈.

The sources may be graphic or video sources, with or without sound, sources in the RGB format or more generally any image source in a format known per se, adapted to be displayed in a display device. Available standards for video sources notably comprise PAL, SECAM, NTSC and Japan. For each of these standards, various substandards may exist, such as M, N or 4.43 for NTSC. Standards for graphic sources comprise interlaced or non-interlaced VGA, SVGA, XGA, SXGA, UXGA or other standards used for different image resolutions. The various standards or formats of images—video or graphics—that may be used for the image sources only depend on displaying capabilities of the displays devices used in the image distribution system. The examples given above should not be construed as limiting the types of images or sources usable according to the invention.

Sources could comprise one or several of CCTVs, DVD players, personal computers or LAN workstations. These sources may output images in various formats, which are multiplexed by multiplexer 2. Various methods may be used for multiplexing images of the various sources. The images are preferably time multiplexed, since this makes it possible to use the same type of cables as in the prior art. Time multiplexing notably makes is possible to use prior art encoding solution at the physical layer of the cable 6 discussed below.

The bandwidth allowed for each source in the multiplexer may be fixed; it may also vary dynamically, according to the types of sources or number of sources inputted to the video wall. This is further discussed below.

The output of the multiplexer 2 is connected to a cable 6. This cable may for instance be a fibre optic cable or a metallic cable. One may use for cable 6 a Digital Visual Interface using the transition minimised differential signalling (TMDS) protocol as serial encoding protocol. Using a DVI format on a single cable provides a maximum rate of 165 Mpixels/second, while a DVI format on a double cable provides a maximum rate of 330 Mpixels/second. One may more generally use other type of transmission protocol on the cable. There may be provided more than one physical cable, e.g. cable 6 could be formed of several parallel physical channels or cables. The generic word “connection” encompasses a single physical cable, or several cable used concomitantly.

The image distribution system further comprises several display devices- three in the example of the figure. Each of the display devices 8, 10 and 12 is connected to cable 6. In the example of the figure, display device 8 is a video wall, while display devices 10 and 12 are monitors. All display devices are connected to the cable, so that the cable serially connects the devices.

Each display devices comprises at least one demultiplexer for demultiplexing images in the multiplexed flow of images provided on the cable. The operation of these demultiplexers is adapted to the operation of multiplexer 2 used for multiplexing images to the cable.

In the example of the figure, display devices 10 and 12 comprise monitors. Each of the display devices further comprises a demultiplexer 14, 16 and a microprocessor or any other computing means 18, 20. The demultiplexer receives multiplexed images from cable 6 and demultiplexes the flow of images received on the cable. The microprocessor selects among demultiplexed images the image or the images to be displayed on the monitor; the microprocessor may also control the demultiplexer, so that the demultiplexer only provides the microprocessor with the required source or sources. The fact that the images are multiplexed makes it possible to select any of the multiplexed images for display on the monitor. More than one image may be displayed if necessary. In addition, it is possible to change the displayed image—that is, select another source or other sources—simply by adequately programming the microprocessor. The microprocessor then controls the demultiplexer so that the demultiplexer provides the required source or sources to the microprocessor. There is no need to change cabling between multiplexer 2 and display devices 10 and 12, even when the source(s) of images to be displayed on a display device need to be changed.

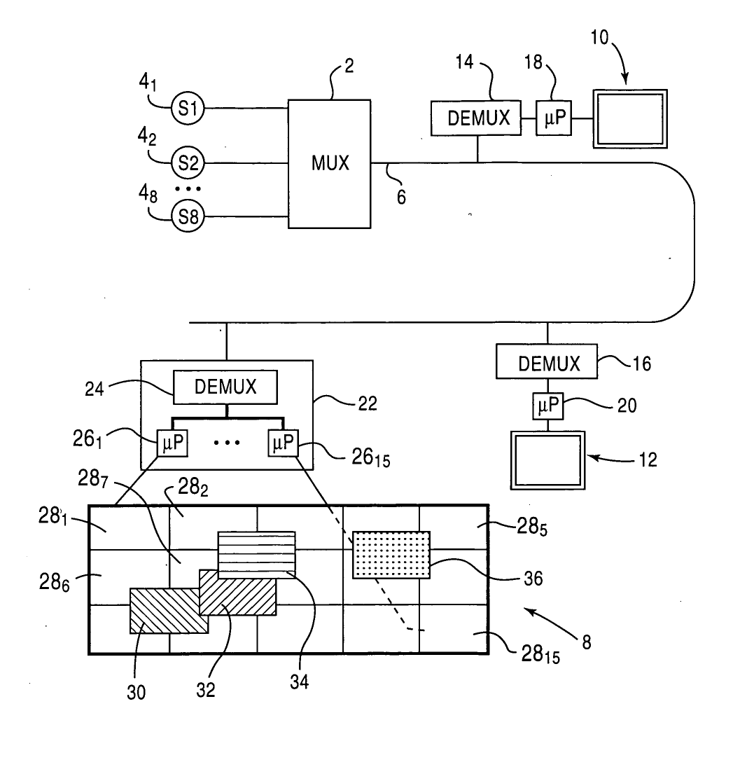

Display device 8 is a video wall of the type represented in FIG. 1 of EP application 02290587, formed of 15 contiguous displays 28₁ to 28₁₅. The video wall comprises a wall circuit 22. The circuit comprises a demultiplexer 24, which demultiplexes the images of the various sources and provides images of the demultiplexed sources to eight outputs. Demultiplexed images are then provided to image processors 26₁ to 26₁₅. As shown by the bold connection in the figure between demultiplexer 24 and processors 26₁ to 26₁₅, the demultiplexed sources are provided to the processors. The bold connection in the figure is actually representative of the number of processors.

Image processors select among the various demultiplexed sources the image(s) or part of image(s) to be displayed; specifically, the processor may display one image, or select on a received source an area to be displayed. In the example represented on the figure, processor 26₂ would select the upper left part of the images 34 of one source for display on the display 28₂. Processor 26₇ would select part of images 30, part of images 32 and part of images 34 for display on display 28₇. Images 36 is an additional image displayed on four displays. A processor may also select various images in different formats, for a picture-in-picture display; the number of images to be displayed on each display is not limited by the number of inputs to the electronic system.

One could also use in video wall 8 the solution of FIG. 2 of EP application 02290587. In this case, the video wall would comprise an image processor in each display of the wall, instead of having the various processors grouped in a single wall circuit 22. In this case, each image processor would further be provided with a demultiplexer or with a demultiplexing stage. The input cable would then be connected in parallel to the demultiplexer of each image processor. The demultiplexer of the processor of each display is thus provided with the multiplexed sources. As in the example of the figure, each demultiplexer may thus demultiplex one or several of the sources, for subsequent display by the processor on the display surface of the corresponding display.

The bandwidth allowed for each source in the multiplexer may be fixed; it may also vary dynamically, according to the types of sources or number of sources inputted to the video wall.

If the bandwidth granted to transmitting a given source is smaller that the throughput necessary for this source, the refresh rate for the images of the source may simply be decreased. This makes it possible to display complete images on the video wall—even if the refresh rate is smaller. The resolution is preferably maintained. For instance, assume each video source has a resolution of 1280*1024 pixels, with three colours R, G and B, each colour being coded on 256 levels or 8 bits. If the refresh rate is 60 images per second, the bandwidth necessary for transmitting one such video source is
1280*1024*60=78 643 200 pixel/s
that is 1.89 Gbit/s.

If the allowable throughput on the cable is 2 Gbit/s, one may allocate 0.25 Gbit/s to each source—in the simplest embodiment where the same throughput is allocated to each source. In this case, the refresh rate for each source would become
60*0.25/1.89=7.9 images per second.
Reducing the refresh rate of the images makes it possible to display images having the optimal resolution. In this case, the number of images per second for one given source in the flow of images of the multiplexed sources is lower than the number of images per second in the source as originally input to the multiplexer. The easiest solution in such a case is to serially transmit one image from each source on the connection 18; in other words, the sources are scanned successively and one image is transmitted each time a source is scanned.

In the example given above, the same refresh rate is applied to all sources; this is not necessary. One may for instance select different refresh rates according to the types of sources; in this case, graphics sources may require a lower refresh rate than video sources. One may also lower the refresh rate for a source, which is not currently being displayed on the video wall. Refresh rates may be varied dynamically, e.g. according to the type of display devices connected to the cable.

If the bandwidth on connection 6 is sufficient, there may not be any need to limit the bandwidth of the sources. For instance, assume connection 18 is formed of two cables each having a bandwidth of 1 Gbit/s. Assume video images have a resolution of 500*500 pixels, with 30 images per second and a coding of each pixel of 24 bits. In this example, the throughput for each video image is 0.18 Gbit/s. If only four sources are multiplexed, connection 6 clearly has enough bandwidth for transmitting the images of the multiplexed sources, with the full resolution and the refresh rate of 30 images/s.

The process for displaying images of the various sources to the various display devices thus involves multiplexing the images of the various sources, transmitting images of the multiplexed sources to the various display devices, demultiplexing the images of the various sources at the video wall and displaying image(s) of the demultiplexed sources at each of the display devices.

The invention is not limited to the embodiments disclosed above. One may use as a display device other types of devices than a video wall or monitor. In case of video walls, the video wall may comprise more or less than 15 displays. The example of the figure shows eight image sources; one may use more or less than 8 sources. There may also be more than one image processor per display. Although this is not represented in the drawings, one may use a several demultiplexers for a single display, for allowing picture-in-picture on the display.

In the description of the preferred multiplexing scheme, the resolution of the images is maintained; this solution is preferred for usual applications of display devices, such as control rooms. One may also decide to decrease resolution of the images of some sources, while keeping the same refresh rate. Both solutions may be combined—some sources having a lower refresh rate and some other a lower resolution. Again, the type of multiplexing may be adapted dynamically.

Last, one may cascade the multiplexer in order to increase the number of sources, while using the same devices. There could also be separate multiplexers for inputting images on cable 6.

In the embodiment described above, the various display devices are connected in series to connection 6. They may relay the signal, to increase propagation length. The display devices may also simply read the signal; in this case, the fact that one of the display devices is operating or not is irrelevant to the operation of the other display devices.

In all figures and explanations, item not related to the invention—such as possible amplifiers—are not represented.

1. An image distribution system, comprising
a multiplexer (2) having at least two inputs adapted for receiving images from at least two sources (4₁, 4₈), the multiplexer being adapted for multiplexing images received on said inputs and outputting on a connection (6) multiplexed images;
at least two separate display devices (8, 10, 12), each of said separate display device being connected to the connection (6) and having a demultiplexer (14, 16, 24) adapted for receiving multiplexed images and outputting demultiplexed images.

2. The system of claim 1, wherein the multiplexer (2) is adapted for time-multiplexing images received on said inputs.

3. The system of claim 1, wherein the number of images per second for one source in the images from multiplexed sources is lower the number of images per second for said source provided on said multiplexer input.

4. The system of claim 1, wherein the demultiplexer (14, 16, 24) in a display device (8, 10, 12) is adapted to output demultiplexed images from any one of the multiplexed images.

5. The system of claim 1, wherein said display devices comprise a video wall (8) having at least two displays (28₁, 2815) forming a continuous or quasi-continuous display surface.

6. The system of claim 5, wherein the video wall comprises one demultiplexer (24) and wherein said demultiplexer is adapted to provided the images from demultiplexed sources to each of said displays (28₁, 28₁₅).

7. The system of claim 5, wherein each display (28₁, 28₁₅) in the video wall comprises a demultiplexer and a processor, and wherein a demultiplexer is adapted to the images from demultiplexed sources to the processor.

8. A process for distributing images to at least two separate display devices (8, 10, 12), the process comprising:
multiplexing images received from at least two sources (4₁, 4₈);
providing over a connection (6) multiplexed images to each of said separate display devices (8, 10, 12);
at each of said separate display devices, demultiplexing the received images and displaying images of at least one of said sources.

9. The process of claim 8, wherein the step of multiplexing comprises time-multiplexing the received images.

10. The process of claim 9, wherein the step of multiplexing further comprises reducing the number of images per second for at least one of said sources.

11. The process of claim 8, wherein the step of providing comprises providing all multiplexed images to each of said separate display devices (8, 10, 12).

12. The process of claim 8, wherein the step of providing is carried out over a single connection, all display devices (8, 10, 12) being serially connected on said connection (6).
